(19) United States
(12) Patent Application Publication
(10) Pub. No.: US 2022/0327565 A1
(43) Pub. Date: Oct. 13, 2022

(54) METHOD AND SYSTEM FOR IMPROVING PREDICTIONS OF DEMAND FOR RIDE HAILING SERVICES

(71) Applicant: Suol Innovations Ltd., Nicosia (CY)

(72) Inventor: VIKTOR SVETOSLAVOVICH BORISOV, Yakutsk (RU)

(21) Appl. No.: 17/562,197

(22) Filed: Dec. 27, 2021

(30) Foreign Application Priority Data
Apr. 7, 2021 (RU) 2021109554

(51) Int. Cl. G06Q 30/02; G06Q 30/08; G06Q 10/06; G06Q 50/30; G06N 20/00

(52) U.S. Cl. CPC G06Q 30/0205; G06Q 30/0206; G06Q 30/08; G06Q 30/0283; G06Q 10/06315; G06Q 50/30; G06N 20/00

(57) ABSTRACT

Method for predicting when rush hour demand for ride services exceeds supply, including, on a server, receiving ride requests from riders' devices, the requests including a ride price offer; receiving ride request responses from drivers' devices with a counteroffer; (i) analyzing number of ride requests within given period of time and number of unique riders sending ride requests within given period of time; (ii) analyzing number of drivers in the geographic area, number of drivers responding to a request within a given period of time, a number of unique riders whose requests have been responded to within a given period of time, and drivers' counteroffers; identifying true rush hour when demand for ride services exceeds supply and any false rush hours, based on (i) and (ii); raising pricing and/or increasing supply of ride services by calling in more drivers only for the true rush hour, ignoring false rush hours.

### CROSS REFERENCE TO RELATED APPLICATIONS

This application claims priority to RU 2021109554, filed Apr. 7, 2021, incorporated herein by reference in its entirety.

### BACKGROUND OF THE INVENTION

### Field of the Invention

The invention relates to administrative, commercial, financial, managerial, monitoring and predicting methods, and, more particularly to prediction of demand for ride hailing services.

### Description of the Related Art

There is a conventional method for controlling the vehicle allocation system based on predicted ride requests (see U.S. Pat. No. 6,453,298 B2). The known vehicle allocation system controls a plurality of autonomous vehicles used to transport passengers between major destination points, such as airports, railway terminals, shopping malls, etc. The vehicle allocation system sets the search interval and predicts passenger requests and the state of tracked vehicles within this interval. A pre-determined number of vehicles are allocated to each destination point in the given area. Each destination point includes a parking lot or a queueing space to accommodate waiting vehicles and a terminal that notifies the main computer about the number of vehicles currently available, passenger requests for vehicles, vehicle destination information, arrival information, etc. The main computer has a memory, which stores the predicted demand data, based on the history of past requests. The main computer calculates any excesses or shortages of vehicles at destination points, based on the predicted demand data and information obtained from terminals over the search interval. Based on the calculation results, vehicles are reallocated from destination points which have an excess number of vehicles to destination points which do not have enough vehicles.

However, this solution uses a prediction approach based on previously stored pick-up points and drop-off points, which does not provide enough accuracy when predicting the moment when demand exceeds supply.

Another conventional solution involves traffic predictions using real transport data (see U.S. Pat. No. 9,286,793 B2). The time and spatial data for transport networks obtained in real time can be used to study the traffic behavior at different times and in different places, which may potentially result in significant savings in terms of time and fuel consumption. The real data from transport networks can be used to incorporate internal behavior data into the time series mining method in order to improve the accuracy of traffic predictions. For instance, rush hour and event behaviors in time and space can be used in order to improve the accuracy of both short-term and long-term predictions of average speed on a portion of the road, even if there has been a road incident (e.g., traffic accident). By taking into account historical rush hour behavior, it is possible to improve the accuracy of conventional short-term and long-term predictions from 67% to 78%, respectively. In addition, impacts from traffic accidents can be taken into account in order to further improve the accuracy of predictions to 91%.

However, this solution uses a different prediction approach that does not use data from the communication between the rider and driver prior to the ride, which does not provide enough accuracy when predicting the moment when demand exceeds supply.

Yet another solution (see CN110458337A, published on Nov. 15, 2019), discloses a neural network for predicting vehicle supply and demand by collecting all ride data, as well as extracting characteristics and reducing dimensionality using convolutional neural networks. The extracted characteristic spectrum is inputted into a gated recurrent neural network. In order to obtain pure vehicle demand information, the model is adjusted during training, and pure vehicle supply information and the resulting demand-supply difference are predicted using the adjusted model.

However, this solution does not use data from the communication between the rider and driver prior to the ride, which does not provide enough accuracy when predicting the moment when demand exceeds supply. Accordingly, there is a need in the art for a system for predicting peaks in demand more accurately, and notifying riders about increased demand for ride services, so that they can make an informed ride price offer to the drivers.

### SUMMARY OF THE INVENTION

The main problems to be solved are accurately predicting increased demand for ride services (such as during rush hours) and notifying riders and/or drivers of such demand, and managing supply of drivers, in order to improve the quality of ride services and better manage supply of ride services.

In the system for requesting ride service, the rider and the driver are able to communicate in order to negotiate the price of the ride. Based on the characteristics of such negotiations between a plurality of riders and a plurality of drivers, it is possible to determine that demand for ride services exceeds supply. The solution uses historical data, geographical data, time data and rider-driver negotiation data to predict the moment of demand for ride services exceeds supply (such as during rush hour) with high accuracy.

Thus, the objective is to make more accurate predictions of demand for ride services exceeding supply.

In one aspect of the invention, there is provided a method for assessing the accuracy of a prediction that demand for ride services exceeds supply, the method comprising the following steps: receiving ride requests from riders' devices in a city sector or some other defined geographic area via a communications server, the requests containing a ride price offer; receiving ride request responses from drivers' devices via the communications server, the responses containing a return ride price offer (counteroffer); receiving ride demand data via the communications server, based on the analysis of at least the number of ride requests in a city sector within a given period of time and the number of unique riders sending ride requests in a city sector within a given period of time, obtained from ride requests received from a plurality of riders' devices; receiving ride supply data via the communications server, based on the analysis of at least the number of unique drivers responding to a request from a city sector within a given period of time, the number of unique riders in a city sector, whose requests have been responded to within a given period of time, and drivers' return ride price offers, obtained from ride request responses received from a plurality of drivers' devices; and via the communications server, assessing the accuracy of the prediction that demand for ride services exceeds supply, based on the ride demand data and ride supply data.

Additionally, ride request responses are received only from drivers within a pre-set distance from riders; the accuracy of the prediction that demand for ride services exceeds supply is assessed using machine learning; the accuracy of the prediction that demand for ride services exceeds supply is assessed using gradient boosting; and the user is notified that demand for ride services exceeds supply.

In another aspect, there is provided a system for assessing the accuracy of a prediction that demand for ride services exceeds supply, the system including a rider's mobile device adapted to get ride requests with a ride price offer and send them via a server; a driver's mobile device adapted to receive ride requests, get ride request responses, and send them via the server; a server adapted to provide communication between the rider's mobile device and the driver's mobile device; wherein the server is adapted to receive ride demand data via the communications server, based on the analysis of at least the number of ride requests in a city sector within a given period of time and the number of unique riders sending ride requests in a city sector within a given period of time, obtained from ride requests received from a plurality of riders' devices; wherein the server is adapted to receive ride supply data via the communications server, based on the analysis of at least the number of unique drivers responding to a request from a city sector within a given period of time, the number of unique riders in a city sector, whose requests have been responded to within a given period of time, and drivers' return ride price offers, obtained from ride request responses received from a plurality of drivers' devices; and wherein the server is adapted to assess the accuracy of the prediction that demand for ride services exceeds supply, based on the demand and supply data.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates graphs for rides and ride requests.

FIG. 2 illustrates the screen for bargaining with the rider.

FIG. 3 illustrates rush hour estimation.

FIG. 4 illustrates a city divided into sectors.

FIG. 5A shows exemplary analysis of historical data.

FIG. 5B illustrates the prediction results and their comparison with the real situation.

FIG. 6 is a diagram for the rush hour prediction system.

FIG. 7 is a detailed diagram for the rush hour prediction system.

FIG. 8 shows an exemplary server or a general purpose computing device that may be used in the invention.

FIG. 9 is a block diagram of an exemplary mobile device that can be used in the invention by the passenger(s) and/or the driver(s).

FIG. 10 is a block diagram of an exemplary implementation of the mobile device.

### DETAILED DESCRIPTION OF EMBODIMENTS OF THE INVENTION

Reference will now be made in detail to the preferred embodiments of the present invention, examples of which are illustrated in the accompanying drawings.

In the present disclosure, a situation, in which demand exceeds supply, is designated as a “rush hour”. Although rush hours usually occur in the morning or in the evening as many people need commute to or from work and thus more rides are requested, similar situations may also caused because of local events or emergencies (concerts, sports games, parades, heavy snowfalls, etc.).

A rush hour occurs when many riders generate ride requests, but there are not enough drivers to respond.

In the proposed ride-sharing system, a rider offers their own ride price via the application, and drivers either accept it or start negotiating a higher price. If riders set a price that is too low, many of them may not have the chance to find a driver at all, which causes customer dissatisfaction. The timing of the ride price offers and driver counteroffers also may be relevant (i.e., how fast a rider or driver responds).

There are two possible ways for resolving this problem: either by adding more drivers or by limiting the number of rides. As it tends to be fairly difficult to increase the number of drivers, limiting the number of rides seems more reasonable (if a rider is unable to make a ride request because they consider the price too expensive, they will not be as dissatisfied as they would be if there were no ride at all).

When the ride price goes up, some riders will forfeit their rides, while others will agree to such terms. In the end, those who need the ride more will get the ride. Therefore, there is a need in the art for a system for notifying riders about increased demand for ride services, so that they can make an informed ride price offer to the drivers.

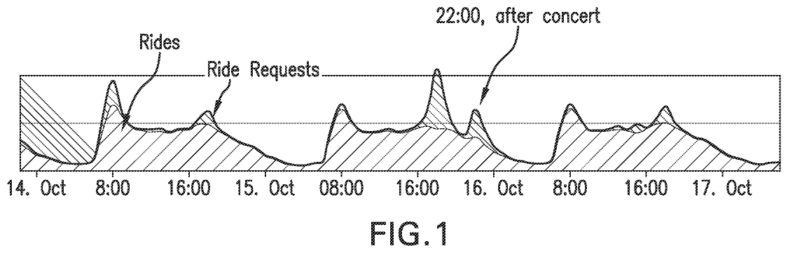

FIG. 1 is a diagram showing a demand curve (upper) and a supply curve (lower). As can be seen from FIG. 1, the supply curve does not have significant fluctuations during the three days (October 14-16), but the demand curve has sharp peaks (in the morning and in the evening), especially on October 15. October 15 peaks are caused by an increased demand before and after a concert. The peak of demand before the concert coincides with the usual evening peak of demand, and therefore, more than a half of riders could not get their rides.

If they were notified in advance that there is an (impending) increase of demand for ride services, this would have decreased their dissatisfaction due to being unable to get a ride when it was needed. As a result those who need a ride most will offer higher prices and they will more likely get a ride.

Usually, similar services regulate ride prices automatically, generating price offers based on the analysis of historical data. In the service disclosed herein, the ride price is negotiated by the rider and the driver, which makes the pricing more flexible, but the rider may propose a price that is inappropriate to the current situation due to the lack of awareness, based on their past experience only. However, at the same time, the price negotiations between the rider and the driver provide valuable information about the current traffic situation, as the drivers see an increased demand and start to accept more favorable offers, ignoring less favorable ones.

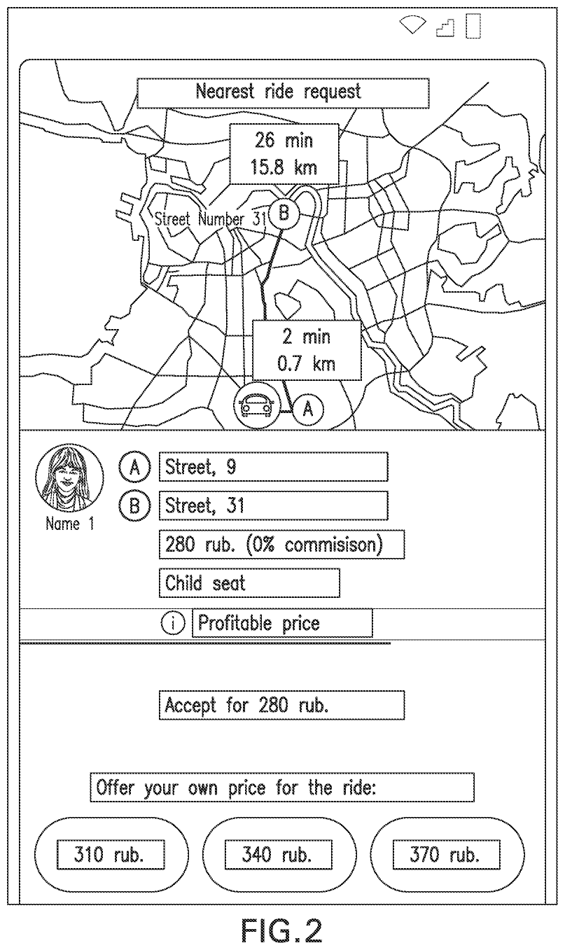

FIG. 2 is an exemplary illustration of the driver's app screen, in which the rider's price offer (RUB 280) is shown, along with alternative variants that the driver may respond with (here, in rubles): RUB 310, RUB 340, or RUB 370. The ride price and currency may differ depending on the ride distance, geographical area, and other factors.

Both the rider and the driver install an application on their mobile devices, which provides the interface for communication via the Internet. The application enables price negotiations between the rider and the driver, taking into account rush hour conditions.

A rush hour may occur:

By time:
in the morning or in the evening;
because of some situation (e.g., rainfall, snowfall, traffic accident);

By location:
in the entire city (usually in the morning or in the evening, or because of weather, for example);
in some area of the city (because of a local event, such as a concert).

The following variables are used to detect a rush hour:
datefield—the day and hour of observation,
num_order—the number of ride requests,
num_try—the number ride requests with negotiations (when it took several tries before the driver accepted),
num_user—the number of unique riders,
react=num_try/num_order—the share of ride requests that got a driver's response.

The processing of these data results in the following value: rush_hour={0, 1}, which shows whether a rush hour has occurred.

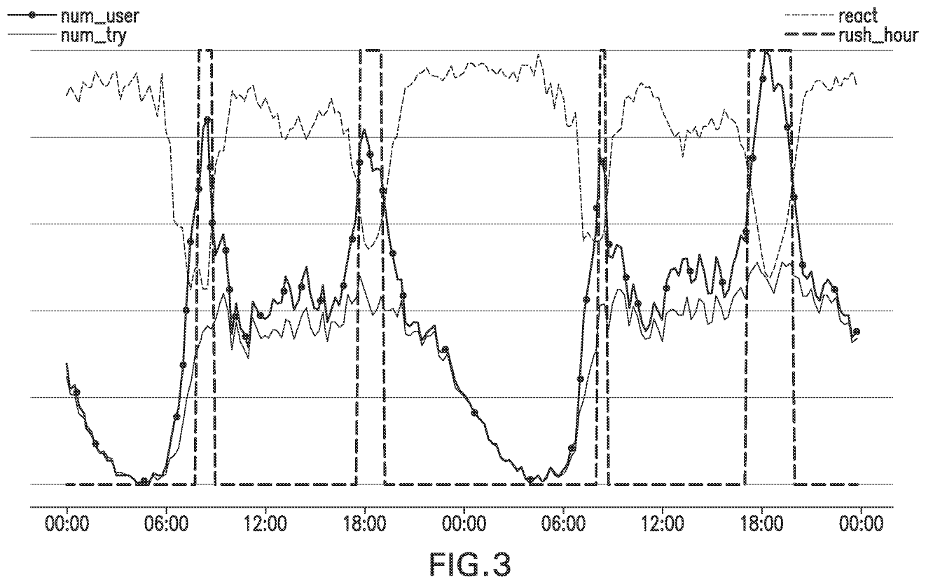

Below is an exemplary mathematical model used to plot graphs shown in FIG. 3:
react=num_try/num_order
threshold_react=median(react)−alpha*std(react)
threshold_user=median(num_user)−alpha*std(num_user)
rush_hour=1 if react<threshold_react and num_user>threshold_user else 0
alpha=1.0

Other mathematical models can be used, which lies within the subject matter of the claimed solution, which in no way limits the scope of the present invention as defined by the claims.

FIG. 3 illustrates the results of processing historical data in accordance with the model. As can be seen from FIG. 3, when the num_user value is high, demand inevitably starts to exceed supply.

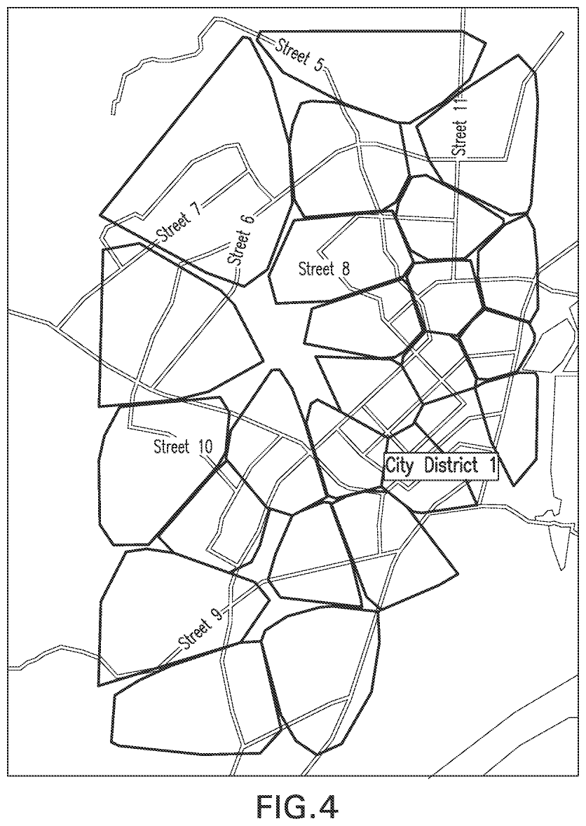

In order to predict rush hours more precisely, the city has to be divided into sectors. Otherwise, local spikes of demand will not be seen in the overall picture. FIG. 4 illustrates how the city is divided into sectors. The division can be made using any suitable method. The solution uses the conventional K-Means algorithm. (en.wikipedia.org/wiki/K-means_clustering) For each sector, the following parameters are calculated:
passenger_count—the number of unique riders in the sector for the past 15 mins;
done_count—the number of rides in the sector for the past 15 mins.

And the following values are displayed to a decisionmaker (e.g., someone responsible for a particular region or city, so that he can make decisions about how to respond to the peak, e.g., call in more drivers, raise prices, etc.—alternatively, this can be done automatically, where, for example, drivers who are not currently on duty get a pre-recorded text calling them to work, prices for rides are raised automatically by some percentage, and so on):
failed=passenger_count−done_count
done_per_passenger=min(1, done_count/passenger_count)

Subsequently, the rush hour threshold is determined.

The following statements are used as guidelines:
If the done_per_passenger value is low, then the share of successful rides is low, perhaps, due to the lack of drivers.
If the failed value is high, then many riders (an absolute value) could not get a ride.

The thresholds are individual for each sector. In order to calculate them, the vectors of the done_per_passenger and failed values are clustered using the K-Means algorithm (for k=3 and using the Euclidean distance). Time periods that fall into the cluster farthest from 0 are considered to be periods of increased demand. This results in a set of marked data that will be used in order to predict rush hours.

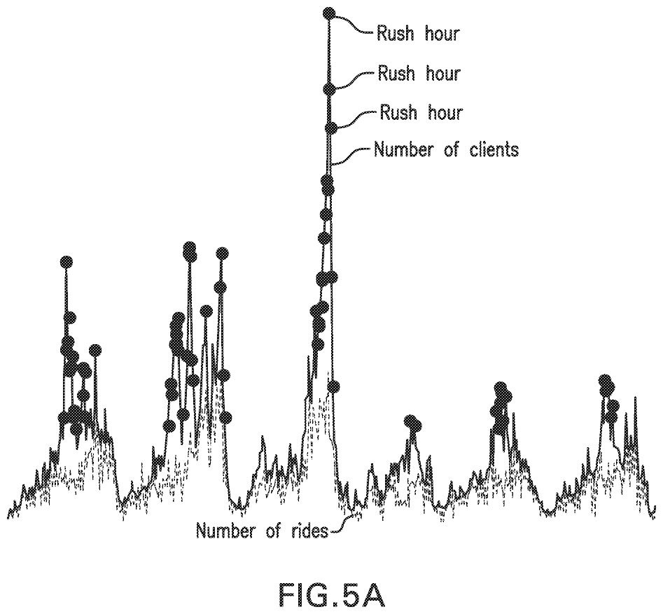

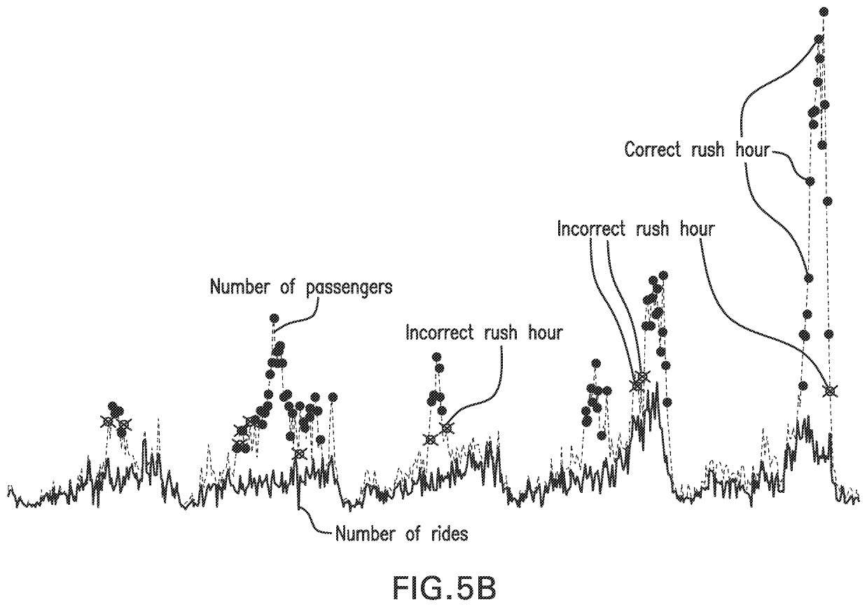

The graph in FIG. 5A was plotted based on the analysis of historical data. The graph points symbolize the number of riders, the total number of rides, and rush hour moments, respectively.

In order to detect a possible rush hour in the future, the information about communication between the rider and the driver is used, particularly, the information about their ride price negotiations. The analysis of such communication showed that 95% of ride price negotiations occur within two minutes after the rider has made a ride request. From the rider's point of view, the negotiations may result in them (i.e., the riders) either agreeing to take a ride at the negotiated price, refusing to accept the price offered by the driver, cancelling their ride request, or deciding to wait for a better offer. From the driver's point of view, the negotiations may result in them (i.e., the drivers) accepting the ride request or the rider cancelling their ride request.

The following sets of data are used to predict rush hours:
order_count—the number of ride requests in a given sector within a given time period,
passenger_count—the number of unique riders in a given sector within a given time period,
bid_driver_count—the number of unique drivers who started ride price negotiations in a given sector within a given time period,
bid_passenger_count—the number of unique riders who negotiated their ride prices in a given sector within a given time period.

These sets of data are analyzed using machine learning algorithms, particularly gradient boosting, to detect moments having the characteristics of a rush hour. Machine learning is performed using historical data, and then the trained model is used to detect a possibility of a rush hour. A neural network can be used as well.

In order to improve the accuracy of the model, such techniques as scaling, stacking, or selection of hyperparameters can be used.

FIG. 5B illustrates the prediction results and their comparison with the real situation. As can be seen from FIG. 5B, the proposed method for predicting that demand for ride services exceeds supply provides a high prediction accuracy of 95% with 67% recall.

Such a high accuracy is due to the fact that the method uses data directly related to rush hours.

Therefore, based on the analysis of historical and current data using a trained model, it is possible to detect the likelihood of a rush hour occurring within the upcoming time period. Obviously, it is possible to derive an empirical correlation between the input and output data, creating a mathematical formula, into which the input data can be substituted to predict a rush hour instead of using machine learning, but this is not the part of the claimed solution.

One of the main features of the ride-sharing service disclosed herein, namely, price negotiations between riders and drivers before the ride is accepted, results in new data, which can be analyzed to obtain additional information connected that can be used to predict rush hours.

The number of ride requests in a given sector within a given time period (e.g., 5, 10, 15 mins, etc.) is directly connected with rush hours, as the more ride requests there are, the more difficult it is to complete all of them.

Please note that both the number of ride requests and the number of unique riders are important, as a single rider may create multiple ride requests within a given time period.

Another important parameter is the number of unique drivers who start negotiations, i.e., display their eagerness to accept the ride request. Obviously, the fewer drivers are there in the sector, the higher the probability of a rush hour is.

Yet another important parameter is the number of unique riders in the sector who negotiated their ride prices. Not every price offer of a unique rider gets a response from a driver who either accepts it or starts negotiating the price. If there were no price negotiations for a large number of ride requests, this, too, indicates the onset of a rush hour

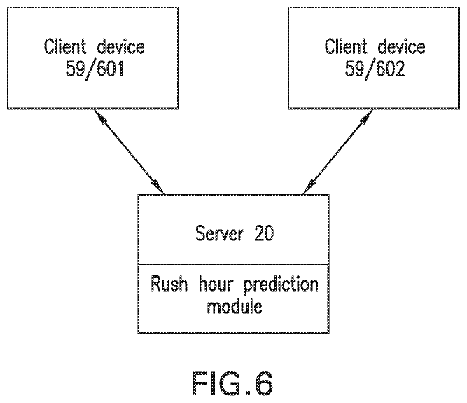

The entire set of data is processed on a server, as shown in FIG. 6. The client's device 59 or 601, on which the ride-sharing app is installed, and the driver's device 59 or 602, on which the app for receiving ride requests from riders is installed, exchange data with the server 20. Units 601, 602, and 20 communicate via a communications medium, particularly, the Internet.

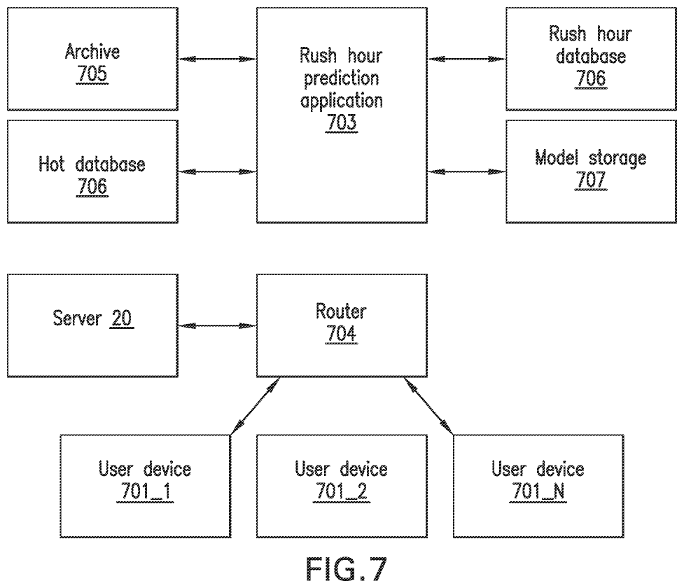

FIG. 7 is a more detailed variant of FIG. 6. Service users exchange data with the server 20, on which the service operates, using their user devices 701, the application 703 for predicting rush hours being a separate component of the diagram. Data streams between user devices 701, the server 20, and the application 703 are routed by the router 704.

Riders communicate with the server 20, which processes the rider's request, particularly, the server 20 sends the rider's request to the application 703 to conduct a rush hour check.

The application 703 uses data from the archive 705 (archive database) to create a rush hour prediction model, and it uses real data from the hot database 706 when servicing riders.

The application 703 processes two types of requests:

1. Administrator requests to create monitoring models.

2. User requests to provide information about the rush hour.

When creating a model, the data is taken from the archive database 705. Using these data, the model is parsed and converted into binary files (Pickle files), which are then stored in the model storage 707, while the parameters of the model (creation time, city code, method) are stored in the rush hour database 706.

The software can be implemented in any suitable programming language and can be stored on any suitable data carrier in a computing means. The software is adapted to instructing the computing means to receive, process, display data.

In an exemplary embodiment, the proposed solution is a system for communication between riders and drivers, which is based on mobile communications devices (phones, tablets, etc.) and has specific functions. Users install an application on their communications devices, which provides the necessary functions for ride price negotiations between riders and drivers.

A rider inputs at least some of the following data into the software application: destination, pick-up point, ride price, vehicle requirements, driver requirements, safety sea requirements, etc. A driver sees the rider's request and their requirements and then either accepts the terms of the ride or offers an alternative ride price.

The rider sees drivers' responses and then either accepts one of the offers, waits for a better offer, or inputs a new request.

Riders and drivers communicate with each other via the Internet; data from the rider's app are sent to the server, processed there and then are forwarded to drivers; drivers respond to the rider's request, their responses are forwarded to the rider via the server; and the process is repeated until the offer is finalized and accepter, or cancelled altogether.

The offer can be negotiated by both sides, i.e., the rider and the driver. In most ride services, there are no such negotiations; the app sets the price automatically, based on the data provided by the rider, and drivers either accept or decline this fixed offer.

Not only do ride price negotiations between the rider and the driver improve pricing flexibility, they also provide additional information for predicting rush hours. During rush hour, the number of ride requests increases; riders repeat their requests more often in case they are unable to finalize the offer immediately; drivers start to negotiate the ride price more often, and they tend to ignore a lot of requests as they are already performing the ride, etc.

These signs can indicate the rush hour, thus notifying the riders that it would be advisable to increase their ride price offer in order to improve their chances of finding a driver, since it is unlikely that they would find a driver at a regular price.

In some embodiments, the app screen on the driver's mobile device can also display a rush hour indicator for a particular city sector (or for the whole city), or a predictive rush hour indicator, showing that rush hour is expected to occur in the near future. This can be done for some percentage of the drivers, e.g., to preemptively increase the supply of ride services in a sector. In some embodiments, the app screen on the driver's mobile device can also display a rush hour indicator for a particular city sector, or a predictive rush hour indicator. This can be done for some percentage of the drivers, e.g., to preemptively increase the supply of ride services in a sector.

In some embodiments, the server forwards the ride request only to the drivers who are located within a predetermined distance from the pick-up point, or who are capable of reaching the pick-up point from their current location within a predetermined time. This distance and time are determined by the server based on the data obtained from the driver's mobile device (location) and the rider's mobile device, as well as additional data, such as speed, traffic situation, etc. This solution allows to detect sectors, in which there is a rush hour, since only the data from the drivers in the given sector are used.

In some embodiments, the driver's app suggests an alternative ride price that the driver may offer to the rider in response to the original ride price. The alternative ride price may include several variants. Also, the driver has an option to input their own ride price. The ride price set by the driver is another indicator of demand exceeding supply, since some drivers, who see or anticipate increased demand, offer higher ride prices, which is a characteristic of the rush hour.

It was found that gradient boosting (en.wikipedia.org/wiki/Gradient_boosting) is the most accurate method for predicting a rush hour using the available data. This method demonstrates 95% accuracy when predicting rush hours based on the aforementioned data.

By using the proposed solution, it is possible to optimize computing resources, particularly, to improve processing time utilization, reduce downtime and the number of calculations, when they do not result in a ride. This is achieved by a number of embodiments:

The proposed technology improves the accuracy of predicting the time and place of increased demand Increased demand entails increased memory, processing power, and communications channel requirements. Knowing the time and place of increased demand, it is possible to set aside certain capacities for the predicted load in advance (e.g., 5 minutes before the demand increases).

Similarly, knowing the place of the predicted demand increase, it is possible to reconfigure user traffic routers in advance, so that the time of sending ride requests (and receiving responses) in a given area were minimal. Otherwise, the required capacities can be activated directly in the places of predicted demand increases.

Knowing periods of predicted demand increases, it is possible to predict periods of decreased demand During these periods, reduction of computing resources can be planned in advance (by turning them off, putting them into an idle state, or transferring them to other computing tasks). Otherwise, too many computing resources would have to be kept ready for a peak load at all times even if there is none.

It is obvious that the capacities not in use can be turned off just as the incoming load decreases. However, extra time may be needed to detect such a decrease in a regular mode. In addition, the observed decrease may be a statistical deviation, and not a decrease. If the technology disclosed herein is used to calculate periods, in which increased demand is not expected, reduction of computing resources can be planned in advance.

Another improvement brought by predictions of increased demand for ride services is that, upon launching the app and seeing an increased demand notification, riders may forfeit their rides because prices will be higher than usual. Therefore, they will not request rides for which no driver would be found.

Request reception, ride creation, and driver search also consume computing resources. Yet another improvement brought by predictions of increased demand for ride services involves reduction of ride calculation costs (calculating the route, using geolocation services, storing the ride data in the database, etc.) for riders who will not be able to find a driver.

### Example

High demand is predicted in the central part of the city between 6 p.m. and 7 p.m.

During the periods of regular demand, all requests from all riders in a given city may be processed by a single server (n CPU, m Memory, k Hard Disk), on which the services are deployed, and stored in a database located on another server.

During the period of increased demand in the central part of a city, an additional server for processing rides and another database server may be activated just for the riders in the central part of the city during this period. After this period is over, the data from the additional database server may be copied to the main server, while the additional server is turned off or put into an idle state.

Otherwise, if the technology of predicting increased demand is not used, both the main and additional servers would have to be kept ready at all times, even if there is little or no need for the additional one.

The methods disclosed herein comprise one or more steps or actions needed to carry out said methods. These steps and/or actions are interchangeable within a method, without departing from the scope of the present invention, as described in the claims. In other words, if the present disclosure does not explicitly state a specific order of said stages and/or actions, they may be replaced with one another, without departing from the scope of the present invention, as described in the claims.

The present application does not state specifically, which software and hardware are used to implement the units illustrated by the accompanying drawings, but it should be apparent to those skilled in the art that the subject matter is not by any means limited by a specific hardware-and-software embodiment, therefore any suitable software and hardware means may be used. As such, hardware means may include any type of specialized integrated circuits, digital signal processors, digital signal processing devices, programmable logical devices, field-programmable gate arrays, CPUs, controllers, microcontrollers, microprocessors, electronic devices, other types of electronic modules, capable of performing functions disclosed herein, such as computer or any combination of the above.

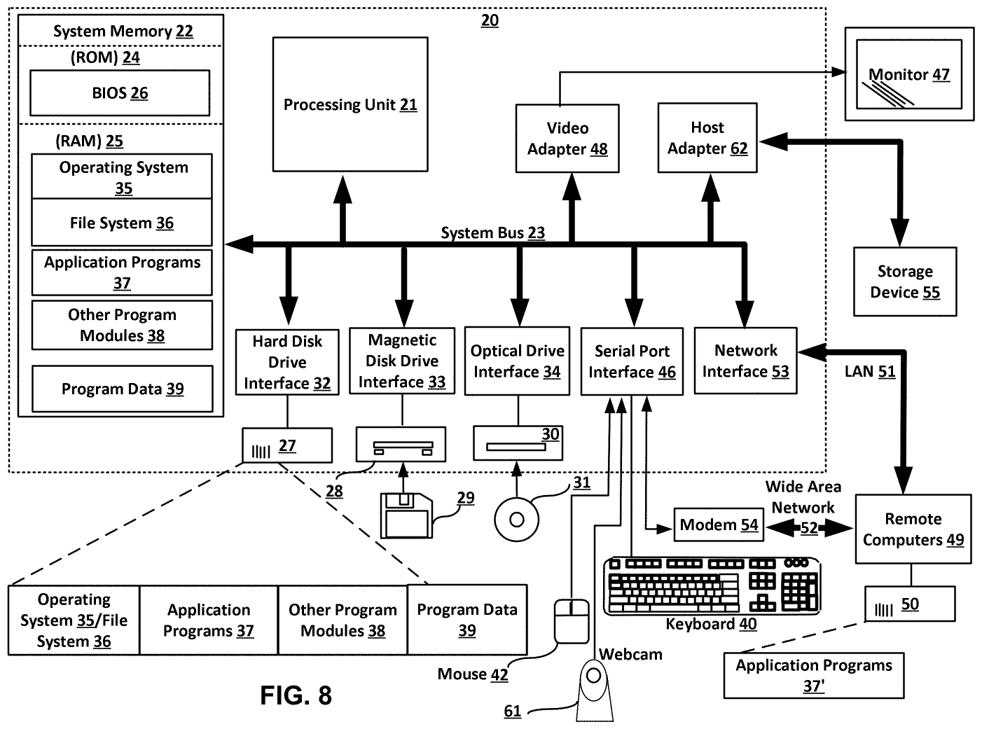

With reference to FIG. 8, an exemplary system for implementing the invention includes a general purpose computing device in the form of a host computer or a server 20 or the like (which may be combined into a distributed system of multiple such servers), including a processing unit (CPU) 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes a read-only memory (ROM) 24 and random access memory (RAM) 25. A basic input/output system 26 (BIOS), containing the basic routines that help to transfer information between the elements within the computer 20, such as during start-up, is stored in ROM 24.

The computer or server 20 may further include a hard disk drive 27 for reading from and writing to a hard disk, not shown herein, a magnetic disk drive 28 for reading from or writing to a removable magnetic disk 29, and an optical disk drive 30 for reading from or writing to a removable optical disk 31 such as a CD-ROM, DVD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively.

The drives and their associated computer-readable media provide non-volatile storage of computer readable instructions, data structures, program modules and other data for the server 20. Although the exemplary environment described herein employs a hard disk (storage device 55), a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk (storage device 55), magnetic disk 29, optical disk 31, ROM 24 or RAM 25, including an operating system 35 (e.g., MICROSOFT WINDOWS, LINUX, APPLE OS X or similar). The server/computer 20 includes a file system 36 associated with or included within the operating system 35, such as the Windows NT™ File System (NTFS) or similar, one or more application programs 37, other program modules 38 and program data 39. A user may enter commands and information into the server 20 through input devices such as a keyboard 40, a webcam 61 and pointing device (e.g., a mouse) 42.

Other input devices (not shown) may include a microphone, joystick, game pad, satellite dish, scanner or the like. These and other input devices are often connected to the processing unit 21 through a serial port interface 46 that is coupled to the system bus, and they may also be connected by other interfaces, such as a parallel port, game port or universal serial bus (USB). A monitor 47 or other type of display device is also connected to the system bus 23 via an interface, such as a video adapter 48. In addition to the monitor 47, computers typically include other peripheral output devices (not shown), such as speakers and printers. A host adapter 62 is used to connect to the storage device 55.

The server/computer 20 may operate in a networked environment using logical connections to one or more remote computers 49. The remote computer (or computers) 49 may be another personal computer, a server, a router, a network PC, a peer device or other common network node, and it typically includes some or all of the elements described above relative to the server 20, although here only a memory storage device 50 with application software 37′ is illustrated. The logical connections include a local area network (LAN) 51 and a wide area network (WAN) 52. Such networking environments are common in offices, enterprise-wide computer networks, Intranets and the Internet.

In a LAN environment, the server/computer 20 is connected to the local network 51 through a network interface or adapter 53. When used in a WAN networking environment, the server 20 typically includes a modem 54 or other means for establishing communications over the wide area network 52, such as the Internet.

The modem 54, which may be internal or external, is connected to the system bus 23 via the serial port interface 46. In a networked environment, the program modules depicted relative to the computer or server 20, or portions thereof, may be stored in the remote memory storage device. It will be appreciated that the network connections shown are merely exemplary and other means of establishing a communications link between the computers may be used.

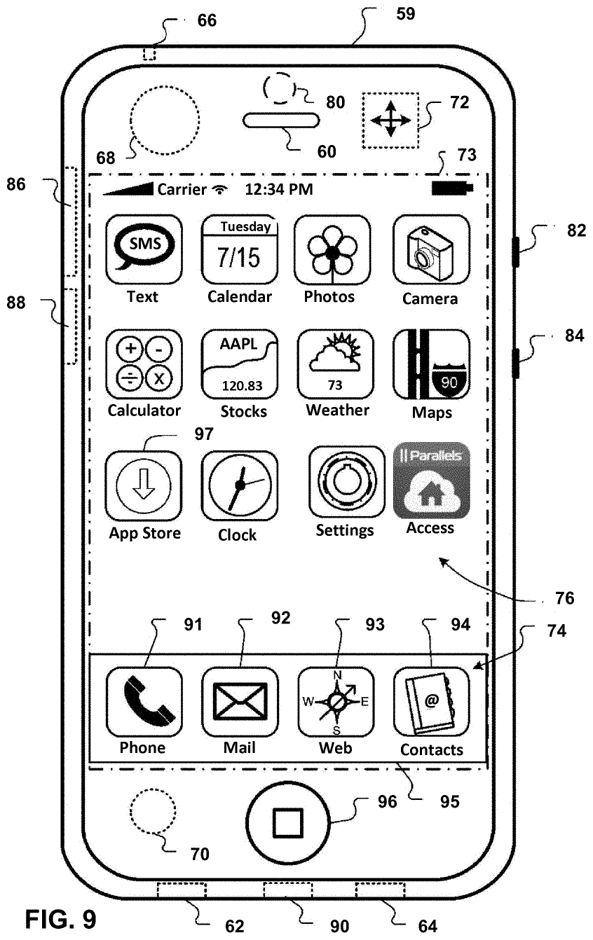

FIG. 9 is a block diagram of an exemplary mobile device 59 on which the invention can be implemented. The mobile device 59 can be, for example, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 59 includes a touch-sensitive display 73. The touch-sensitive display 73 can implement liquid crystal display (LCD) technology, light emitting polymer display (LPD) technology, or some other display technology. The touch-sensitive display 73 can be sensitive to haptic and/or tactile contact with a user.

In some implementations, the touch-sensitive display 73 can comprise a multi-touch-sensitive display 73. A multi-touch-sensitive display 73 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device.

In some implementations, the mobile device 59 can display one or more graphical user interfaces on the touch-sensitive display 73 for providing the user access to various system objects and for conveying information to the user. In some implementations, the graphical user interface can include one or more display objects 74, 76. In the example shown, the display objects 74, 76, are graphic representations of system objects. Some examples of system objects include device functions, applications, windows, files, alerts, events, or other identifiable system objects.

In some implementations, the mobile device 59 can implement multiple device functionalities, such as a telephony device, as indicated by a phone object 91; an e-mail device, as indicated by the e-mail object 92; a network data communication device, as indicated by the Web object 93; a Wi-Fi base station device (not shown); and a media processing device, as indicated by the media player object 94. In some implementations, particular display objects 74, e.g., the phone object 91, the e-mail object 92, the Web object 93, and the media player object 94, can be displayed in a menu bar 95. In some implementations, device functionalities can be accessed from a top-level graphical user interface, such as the graphical user interface illustrated in the figure. Touching one of the objects 91, 92, 93 or 94 can, for example, invoke corresponding functionality.

In some implementations, the mobile device 59 can implement network distribution functionality. For example, the functionality can enable the user to take the mobile device 59 and its associated network while traveling. In particular, the mobile device 59 can extend Internet access (e.g., Wi-Fi) to other wireless devices in the vicinity. For example, mobile device 59 can be configured as a base station for one or more devices. As such, mobile device 59 can grant or deny network access to other wireless devices.

In some implementations, upon invocation of device functionality, the graphical user interface of the mobile device 59 changes, or is augmented or replaced with another user interface or user interface elements, to facilitate user access to particular functions associated with the corresponding device functionality. For example, in response to a user touching the phone object 91, the graphical user interface of the touch-sensitive display 73 may present display objects related to various phone functions; likewise, touching of the email object 92 may cause the graphical user interface to present display objects related to various e-mail functions; touching the Web object 93 may cause the graphical user interface to present display objects related to various Web-surfing functions; and touching the media player object 94 may cause the graphical user interface to present display objects related to various media processing functions.

In some implementations, the top-level graphical user interface environment or state can be restored by pressing a button 96 located near the bottom of the mobile device 59. In some implementations, each corresponding device functionality may have corresponding “home” display objects displayed on the touch-sensitive display 73, and the graphical user interface environment can be restored by pressing the “home” display object.

In some implementations, the top-level graphical user interface can include additional display objects 76, such as a short messaging service (SMS) object, a calendar object, a photos object, a camera object, a calculator object, a stocks object, a weather object, a maps object, a notes object, a clock object, an address book object, a settings object, and an app store object 97. Touching the SMS display object can, for example, invoke an SMS messaging environment and supporting functionality; likewise, each selection of a display object can invoke a corresponding object environment and functionality.

Additional and/or different display objects can also be displayed in the graphical user interface. For example, if the device 59 is functioning as a base station for other devices, one or more “connection” objects may appear in the graphical user interface to indicate the connection. In some implementations, the display objects 76 can be configured by a user, e.g., a user may specify which display objects 76 are displayed, and/or may download additional applications or other software that provides other functionalities and corresponding display objects.

In some implementations, the mobile device 59 can include one or more input/output (I/O) devices and/or sensor devices. For example, a speaker 60 and a microphone 62 can be included to facilitate voice-enabled functionalities, such as phone and voice mail functions. In some implementations, an up/down button 84 for volume control of the speaker 60 and the microphone 62 can be included. The mobile device 59 can also include an on/off button 82 for a ring indicator of incoming phone calls. In some implementations, a loud speaker 64 can be included to facilitate hands-free voice functionalities, such as speaker phone functions. An audio jack 66 can also be included for use of headphones and/or a microphone.

In some implementations, a proximity sensor 68 can be included to facilitate the detection of the user positioning the mobile device 59 proximate to the user's ear and, in response, to disengage the touch-sensitive display 73 to prevent accidental function invocations. In some implementations, the touch-sensitive display 73 can be turned off to conserve additional power when the mobile device 59 is proximate to the user's ear.

Other sensors can also be used. For example, in some implementations, an ambient light sensor 70 can be utilized to facilitate adjusting the brightness of the touch-sensitive display 73. In some implementations, an accelerometer 72 can be utilized to detect movement of the mobile device 59, as indicated by the directional arrows. Accordingly, display objects and/or media can be presented according to a detected orientation, e.g., portrait or landscape. In some implementations, the mobile device 59 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 59 or provided as a separate device that can be coupled to the mobile device 59 through an interface (e.g., port device 90) to provide access to location-based services.

The mobile device 59 can also include a camera lens and sensor 80. In some implementations, the camera lens and sensor 80 can be located on the back surface of the mobile device 59. The camera can capture still images and/or video.

The mobile device 59 can also include one or more wireless communication subsystems, such as an 802.11b/g communication device 86, and/or a BLUETOOTH communication device 88. Other communication protocols can also be supported, including other 802.x communication protocols (e.g., WiMax, Wi-Fi, 3G, LTE), code division multiple access (CDMA), global system for mobile communications (GSM), Enhanced Data GSM Environment (EDGE), etc.

In some implementations, the port device 90, e.g., a Universal Serial Bus (USB) port, or a docking port, or some other wired port connection, is included. The port device 90 can, for example, be utilized to establish a wired connection to other computing devices, such as other communication devices 59, network access devices, a personal computer, a printer, or other processing devices capable of receiving and/or transmitting data. In some implementations, the port device 90 allows the mobile device 59 to synchronize with a host device using one or more protocols, such as, for example, the TCP/IP, HTTP, UDP and any other known protocol. In some implementations, a TCP/IP over USB protocol can be used.

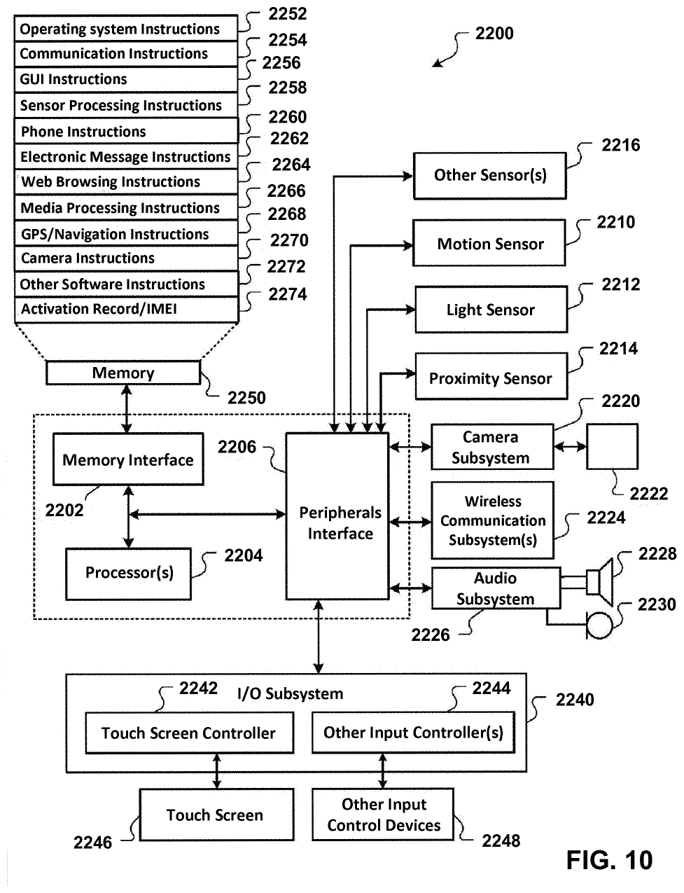

FIG. 10 is a block diagram 2200 of an example implementation of the mobile device 59. The mobile device 59 can include a memory interface 2202, one or more data processors, image processors and/or central processing units 2204, and a peripherals interface 2206. The memory interface 2202, the one or more processors 2204 and/or the peripherals interface 2206 can be separate components or can be integrated in one or more integrated circuits. The various components in the mobile device 59 can be coupled by one or more communication buses or signal lines.

Sensors, devices and subsystems can be coupled to the peripherals interface 2206 to facilitate multiple functionalities. For example, a motion sensor 2210, a light sensor 2212, and a proximity sensor 2214 can be coupled to the peripherals interface 2206 to facilitate the orientation, lighting and proximity functions described above. Other sensors 2216 can also be connected to the peripherals interface 2206, such as a positioning system (e.g., GPS receiver), a temperature sensor, a biometric sensor, or other sensing device, to facilitate related functionalities.

A camera subsystem 2220 and an optical sensor 2222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 2224, which can include radio frequency receivers and transmitters and/or optical (e.g., infrared) receivers and transmitters. The specific design and implementation of the communication subsystem 2224 can depend on the communication network(s) over which the mobile device 59 is intended to operate. For example, a mobile device 59 may include communication subsystems 2224 designed to operate over a GSM network, a GPRS network, an EDGE network, a Wi-Fi or WiMax network, and a BLUETOOTH network. In particular, the wireless communication subsystems 2224 may include hosting protocols such that the device 59 may be configured as a base station for other wireless devices.

An audio subsystem 2226 can be coupled to a speaker 2228 and a microphone 2230 to facilitate voice-enabled functions, such as voice recognition, voice replication, digital recording, and telephony functions.

The I/O subsystem 2240 can include a touch screen controller 2242 and/or other input controller(s) 2244. The touch-screen controller 2242 can be coupled to a touch screen 2246. The touch screen 2246 and touch screen controller 2242 can, for example, detect contact and movement or break thereof using any of multiple touch sensitivity technologies, including but not limited to capacitive, resistive, infrared, and surface acoustic wave technologies, as well as other proximity sensor arrays or other elements for determining one or more points of contact with the touch screen 2246.

The other input controller(s) 2244 can be coupled to other input/control devices 2248, such as one or more buttons, rocker switches, thumb-wheel, infrared port, USB port, and/or a pointer device such as a stylus. The one or more buttons (not shown) can include an up/down button for volume control of the speaker 2228 and/or the microphone 2230.

In one implementation, a pressing of the button for a first duration may disengage a lock of the touch screen 2246; and a pressing of the button for a second duration that is longer than the first duration may turn power to the mobile device 59 on or off. The user may be able to customize a functionality of one or more of the buttons. The touch screen 2246 can, for example, also be used to implement virtual or soft buttons and/or a keyboard.

In some implementations, the mobile device 59 can present recorded audio and/or video files, such as MP3, AAC, and MPEG files. In some implementations, the mobile device 59 can include the functionality of an MP3 player. The mobile device 59 may, therefore, include a 32-pin connector that is compatible with the MP3 player. Other input/output and control devices can also be used.

The memory interface 2202 can be coupled to memory 2250. The memory 2250 can include high-speed random access memory and/or non-volatile memory, such as one or more magnetic disk storage devices, one or more optical storage devices, and/or flash memory (e.g., NAND, NOR). The memory 2250 can store an operating system 2252, such as Darwin, RTXC, LINUX, UNIX, OS X, ANDROID, IOS, WINDOWS, or an embedded operating system such as VxWorks. The operating system 2252 may include instructions for handling basic system services and for performing hardware dependent tasks. In some implementations, the operating system 2252 can be a kernel (e.g., UNIX kernel).

The memory 2250 may also store communication instructions 2254 to facilitate communicating with one or more additional devices, one or more computers and/or one or more servers. The memory 2250 may include graphical user interface instructions 2256 to facilitate graphic user interface processing including presentation, navigation, and selection within an application store; sensor processing instructions 2258 to facilitate sensor-related processing and functions; phone instructions 2260 to facilitate phone-related processes and functions; electronic messaging instructions 2262 to facilitate electronic-messaging related processes and functions; web browsing instructions 2264 to facilitate web browsing-related processes and functions; media processing instructions 2266 to facilitate media processing-related processes and functions; GPS/Navigation instructions 2268 to facilitate GPS and navigation-related processes and instructions; camera instructions 2270 to facilitate camera-related processes and functions; and/or other software instructions 2272 to facilitate other processes and functions.

Each of the above identified instructions and applications can correspond to a set of instructions for performing one or more functions described above. These instructions need not be implemented as separate software programs, procedures or modules. The memory 2250 can include additional instructions or fewer instructions. Furthermore, various functions of the mobile device 59 may be implemented in hardware and/or in software, including in one or more signal processing and/or application specific integrated circuits.

Numerous modifications, changes, variations, substitutions, and equivalents will be apparent to those skilled in the art, without departing from the spirit and scope of the present invention, as described in the claims.

Elements mentioned in singular may also be read in plural, if not stated otherwise.

Functional interconnection between elements should read as an interconnection that allows them to interact correctly with each other in order to carry out their functions. Specific examples of such functional interconnection may include information exchange connections, electric current transfer connections, mechanical movement transfer connections, light, sound, electromagnetic or mechanical oscillation transfer connections, etc. Specific type of functional interconnection is determined by the way said elements are connected to each other and is implemented by conventional means and conventional principles of the art, if not stated otherwise.

Having thus described a preferred embodiment, it should be apparent to those skilled in the art that certain advantages of the described method and apparatus have been achieved. It should also be appreciated that various modifications, adaptations, and alternative embodiments thereof may be made within the scope and spirit of the present invention.

What is claimed is:

1. A method for predicting when rush hour demand for ride services exceeds supply, the method comprising:
on a server, receiving ride requests from riders' devices in a geographic area, the requests including a ride price offer;
on the server, receiving ride request responses from drivers' devices, the responses containing a counteroffer;
(i) on the server, analyzing a number of ride requests in the geographic area within a given period of time and a number of unique riders sending ride requests in the geographic area within a given period of time;
(ii) on the server, analyzing a number of drivers in the geographic area, a number of drivers responding to a request from the geographic area within a given period of time, a number of unique riders in the geographic area whose requests have been responded to within a given period of time, and drivers' counteroffers; and
on the server, identifying true rush hour when demand for ride services exceeds supply and any false rush hours, based on (i) and (ii); and
raising pricing and/or increasing supply of ride services by calling in more drivers only for the true rush hour, while ignoring false rush hours.

2. The method of claim 1, wherein the analyzing in (i) uses gradient boosting.

3. The method of claim 1, wherein the analyzing in (i) uses machine learning.

4. The method of claim 1, wherein the analyzing in (i) and (ii) is also based on weather, events, and day of week.

5. The method of claim 1, wherein the analyzing in (i) also uses the ride price offers.

6. The method of claim 1, wherein the analyzing in (ii) also uses the counteroffers.

7. The method of claim 1, wherein the analyzing in (i) and (ii) is also based on a negotiation process between riders and drivers that includes analysis of all the ride price offers and counteroffers and their timing.

8. The method of claim 1, wherein ride request responses are received only from drivers within a pre-set distance from riders.

9. The method of claim 1, wherein at least some of the riders are notified that demand for ride services exceeds supply.

10. The method of claim 1, wherein at least some of the riders are notified that demand for ride services is expected to exceed supply at a future time.

11. The method of claim 1, wherein at least some of the drivers are notified that demand for ride services is expected to exceed supply at a future time in a particular geographic area.

12. A system for predicting when rush hour demand for ride services exceeds supply, the system comprising:
a server in communication with rider's devices in a geographic area and a plurality of drivers' devices, the server configured to receive ride requests from riders' devices in the geographic area, the requests including a ride price offer;
the server configured to receive ride request responses from drivers' devices, the responses containing a counteroffer;
the server (i) configured to analyze a number of ride requests in the geographic area within a given period of time and a number of unique riders sending ride requests in the geographic area within a given period of time, and (ii) configured to analyze a number of drivers in the geographic area, a number of drivers responding to a request from the geographic area within a given period of time, a number of unique riders in the geographic area whose requests have been responded to within a given period of time, and drivers' counteroffers; and
the server configured to identify true rush hour when demand for ride services exceeds supply and any false rush hours, based on (i) and (ii); and
the server configured to raise pricing and/or increasing supply of ride services by calling in more drivers only for the true rush hour, while ignoring false rush hours.

13. The system of claim 12, wherein the analyzing in (i) uses gradient boosting.

14. The system of claim 12, wherein the analyzing in (i) and (ii) is also based on a negotiation process between riders and drivers that includes analysis of all the ride price offers and counteroffers and their timing.

15. The system of claim 12, wherein ride request responses are received only from drivers within a pre-set distance from riders.

16. The system of claim 12, wherein at least some of the riders are notified that demand for ride services is expected to exceed supply at a future time.

17. The system of claim 12, wherein at least some of the drivers are notified that demand for ride services is expected to exceed supply at a future time in a particular geographic area.
